(19) United States
(12) Patent Application Publication
(10) Pub. No.: US 2026/0044604 A1
(43) Pub. Date: Feb. 12, 2026

(54) METHOD AND APPARATUS FOR VERIFYING INTEGRITY OF FIRMWARE AND RESTORING FIRMWARE

(71) Applicant: Electronics and Telecommunications Research Institute, Daejeon (KR)

(72) Inventors: Seung Yong YOON, Daejeon (KR); Byoung Koo KIM, Daejeon (KR); Joung II YUN, Daejeon (KR); You Sung KANG, Daejeon (KR)

(73) Assignee: Electronics and Telecommunications Research Institute, Daejeon (KR)

(21) Appl. No.: 18/952,266

(22) Filed: Nov. 19, 2024

(30) Foreign Application Priority Data
Aug. 12, 2024 (KR) 10-2024-0107333

(51) Int. Cl. G06F 21/57; G06F 21/32

(52) U.S. Cl. CPC G06F 21/572; G06F 21/32

(57) ABSTRACT

A method and apparatus for verifying integrity of target firmware are disclosed. The method includes dividing original firmware into a plurality of original segments, calculating a hash value for each of the plurality of original segments, dividing the target firmware into a plurality of target segments, calculating a hash value for each of the plurality of target segments; and verifying the integrity of the target firmware by comparing the hash value of the target segment with the hash value of the original segment corresponding to the target segment for each of the plurality of target segments.

### CROSS-REFERENCE TO RELATED APPLICATION

The present application claims priority to Korean Patent Application No. 10-2024-0107333, filed on Aug. 12, 2024, the disclosures of which are incorporated by reference herein in their entireties.

### TECHNICAL FIELD

The present disclosure relates to a method and apparatus for integrity verification and restoration of firmware. More specifically, the present disclosure relates to a method and apparatus for verifying integrity of firmware for a lightweight IoT device and for quickly restoring forged firmware when forgery of the firmware is detected.

### BACKGROUND

The statements in this section merely provide background information related to the present disclosure and do not necessarily constitute prior art.

IoT devices, especially lightweight IoT devices, are interconnected to provide application services in an environment where resources such as CPU performance, memory capacity, battery power, and communication bandwidth are constrained, and thus are exposed to various security vulnerabilities and security threats. Since the lightweight IoT devices are operated in such a resource-constrained environment, it is difficult to apply existing security solutions as they are. Furthermore, most of them do not provide an automatic update function that may immediately apply patches even if security vulnerabilities are found. Accordingly, the lightweight IoT devices are vulnerable to various attacks such as firmware forgery.

Conventional firmware forgery verification techniques have many issues and limitations when applied to actual lightweight IoT devices. The conventional firmware forgery verification techniques verify forgery by using a single hash value or checksum of the entire image of firmware binary as an integrity verification value. When the firmware forgery is detected, the entire firmware image size needs to be transmitted to restore firmware, which causes a significant load in the resource-constrained IoT communication environment and requires a considerable amount of time for restoration. In addition, since the hash key (integrity verification key) for integrity verification is hard coded in a program source code or stored in a non-volatile memory (for example, a flash memory), there has a security vulnerability for key leakage.

Accordingly, an integrity verification method and a restoration method are needed to defend against firmware forgery attacks on lightweight IoT devices.

### SUMMARY

A main purpose of the present disclosure is directed to providing a method and apparatus capable of preventing accidents due to key leakage by generating an integrity verification key using a physically unclonable function (PUF).

Another main purpose of the present disclosure is directed to providing a method and apparatus capable of quickly performing firmware restoration work when firmware forgery occurs by verifying firmware images in a segment unit instead of the entire firmware image at the time of verifying the firmware forgery.

Technical objects to be achieved by the present disclosure are not limited to those described above, and other technical objects not mentioned above may also be clearly understood from the detailed descriptions given below by those skilled in the art to which the present disclosure belongs.

According to an aspect of the present disclosure, a method for verifying integrity of target firmware is provided, the method including dividing original firmware into a plurality of original segments, calculating a hash value for each of the plurality of original segments, dividing the target firmware into a plurality of target segments, calculating a hash value for each of the plurality of target segments; and verifying the integrity of the target firmware by comparing the hash value of the target segment with the hash value of the original segment corresponding to the target segment for each of the plurality of target segments.

According to another aspect of the present disclosure, an apparatus for verifying integrity of target firmware is provided, the apparatus including a memory configured to store one or more instructions; and a processor configured to execute the one or more instructions stored in the memory, wherein the processor executes the one or more instructions to: divide original firmware into a plurality of original segments; calculate a hash value for each of the plurality of original segments; divide the target firmware into a plurality of target segments; calculate a hash value for each of the plurality of target segments; and verify the integrity of the target firmware by comparing the hash value of the target segment with the hash value of the original segment corresponding to the target segment for each of the plurality of target segments.

According to one embodiment of the present disclosure, by generating and managing an integrity verification key using the PUF, there is a benefit of preventing accidents due to key leakage.

According to one embodiment of the present disclosure, by verifying firmware images in a segment unit instead of the entire firmware image at the time of verifying firmware forgery, there is a benefit of being able to check which segment has been forged.

According to one embodiment of the present disclosure, by verifying the firmware images in a segment unit instead of the entire firmware image at the time of verifying firmware forgery, there is a benefit of being able to quickly perform firmware restoration work by updating only the segment where forgery has occurred.

By applying a firmware forgery verification and restoration method according to one embodiment of the present disclosure to various IoT devices such as smart meters (AMI), drones, and CCTVs, there is a benefit of improving the security of IoT devices operating in resource-constrained environments against firmware forgery attacks.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 is a block diagram schematically illustrating a firmware forgery verification and restoration system according to one embodiment of the present disclosure.

FIG. 2 is an exemplary diagram illustrating a method for generating a firmware fingerprint according to one embodiment of the present disclosure.

FIG. 3 is a conceptual diagram illustrating an overall firmware forgery verification process according to one embodiment of the present disclosure.

FIG. 4 is a flowchart illustrating a process in which a fingerprint generation unit generates a fingerprint of an original firmware according to one embodiment of the present disclosure.

FIG. 5 is a flowchart illustrating a process in which an integrity measurement unit and an integrity verification unit verify the integrity of a target firmware according to one embodiment of the present disclosure.

FIG. 6 is a block diagram schematically illustrating an exemplary computing device that may be used to implement a method or apparatus according to one embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

One embodiment of the present disclosure describes a method for generating a firmware fingerprint, a method for generating and managing an integrity verification key using a PUF, and a method for verifying firmware forgery and quickly restoring the same.

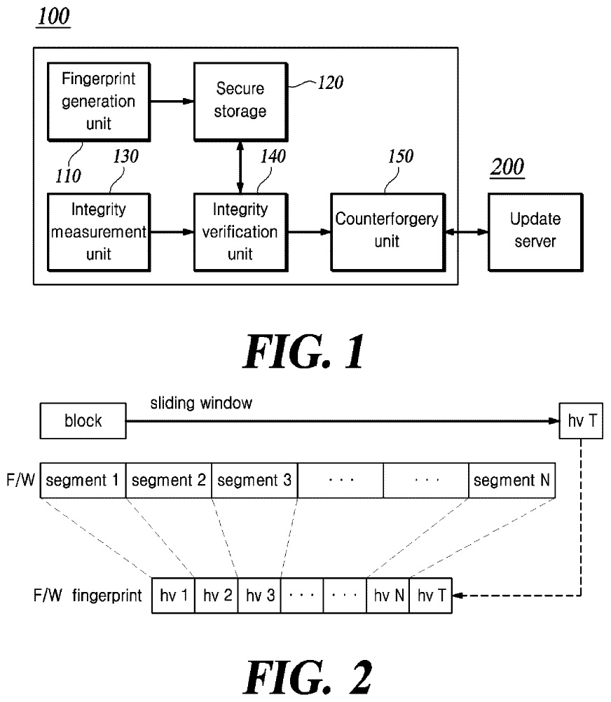

FIG. 1 is a block diagram schematically illustrating a firmware forgery verification and restoration system according to one embodiment of the present disclosure.

The firmware forgery verification and restoration system includes a forgery verification apparatus 100 and an update server 200. The forgery verification apparatus 100 includes a fingerprint generation unit 110, secure storage 120, an integrity measurement unit 130, an integrity verification unit 140, and a Counterforgery unit 150. The forgery verification apparatus 100 may be implemented in the form of an embedded apparatus, and an electronic apparatus within a server. Not all blocks illustrated in FIG. 1 are essential constituents, and some blocks included in the forgery verification apparatus 100 in other embodiments may be added, changed, or deleted. The constituents illustrated in FIG. 1 represent functionally distinct elements, and at least one constituent may be implemented in an integrated form in an actual physical environment.

The fingerprint generation unit 110 may generate a unique fingerprint of the original firmware to be used for integrity verification. The firmware fingerprint is utilized as basic data for verification of forgery. The firmware fingerprint is not simply configured of a single hash value or checksum for the entire binary image, but is configured of a set of hash values generated in units of certain segments.

The secure storage 120 may safely store the unique fingerprint of the original firmware generated by the fingerprint generation unit 110.

The integrity measurement unit 130 may measure the integrity of the firmware to be verified, in other words, a target firmware. The integrity measurement unit 130 sequentially measures the integrity in units of segments for comparison verification with fingerprint, and transmits the measurement result value to the integrity verification unit 140.

The integrity verification unit 140 may receive the fingerprint of the original firmware from the secure storage 120. The integrity verification unit 140 may receive the fingerprint of the target firmware from the integrity measurement unit 130. The integrity verification unit 140 may perform a comparative verification that compares the fingerprint of the target firmware with the fingerprint of the target firmware. The integrity verification unit 140 may verify the integrity by segment unit. The integrity verification unit 140 may store the integrity verification result, and may provide the forgery detection result to the Counterforgery unit 150 when forgery of the target firmware is detected.

When the forgery detection result is received from the integrity verification unit 140, the Counterforgery unit 150 may stop the ongoing process (for example, Booting Process Stop) and perform a response function. The Counterforgery unit 150 may quickly perform firmware restoration work by requesting the update server 200 for a segment in which forgery is detected. The firmware restoration work may be performed by segment unit.

The update server 200 may store and manage an image of the original firmware and information related to the original firmware. The firmware-related information includes version information, update date, update segment information, etc. The update server 200 may perform firmware update work upon receiving a firmware restoration request from the Counterforgery unit 150. The update server 200 may store and manage a segment ID, measured segment hash value, etc. received when the Counterforgery unit 150 requests restoration. The update server 200 may check what firmware forgery attack is taking place in the overall IoT network environment based on the stored segment ID, measured segment hash value, etc.

FIG. 2 is an exemplary diagram illustrating a method for generating a firmware fingerprint according to one embodiment of the present disclosure. In FIG. 2, the firmware (F/W) consists of a total of N segments, and each segment is indicated as segment 1 to segment N. The generation of the firmware fingerprint (F/W fingerprint) is performed using a sliding window technique.

The sliding window is a technique for processing data by setting a window of a certain size in continuous data and moving the window one by one. The firmware image is read in a block unit using the sliding window technique, and a hash value (hv) is generated in a segment unit. For example, HMAC-SHA-256 may be used as a hash function for generating the hash value. The hash value may be generated for all segments of the firmware image. The firmware fingerprint is generated by combining all of the generated hash values (hv1 to hvN).

In one embodiment according to the present disclosure, the final firmware fingerprint may further include a hash value (hvT) for the entire image. By including a hash value for the entire firmware binary image in the firmware fingerprint, the integrity of the firmware may be double-checked, improving the reliability of integrity verification.

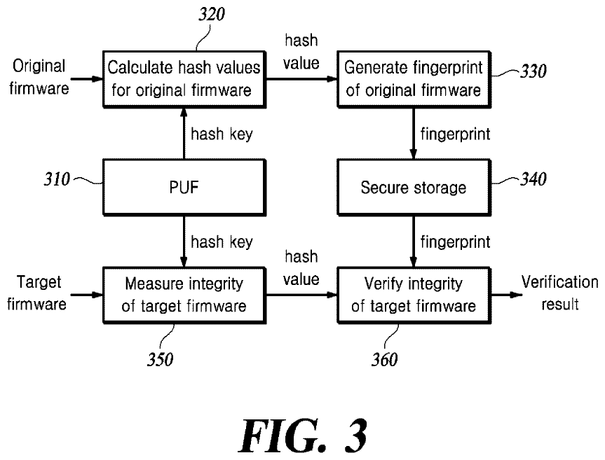

FIG. 3 is a conceptual diagram illustrating an overall firmware forgery verification process according to one embodiment of the present disclosure.

In the process of generating the fingerprint of the original firmware and the process of measuring the integrity of the target firmware, a hash function is used, and it is necessary to fundamentally block the threat of leakage of the hash key (integrity verification key). The method according to one embodiment of the present disclosure addresses this issue by generating and managing a hash key using the PUF (310). The PUF (physical unclonable function) is a technique for generating a security key by using the difference in the microstructure of semiconductors produced in the same manufacturing process. The key generation technique using the PUF does not store a key in non-volatile memory (for example, flash memory), and thus has the advantage of fundamentally blocking accidents due to key leakage. The generation of a hash key using the PUF extracts unique characteristic values through hardware primitives (for example, SRAM, DRAM, Flash, etc.), and performs error correction and stabilization work through an integrity verification key generation process.

The hash value of each segment and the entire firmware image is calculated using the hash key generated using the PUF (320). By generating a hash key only when necessary in the hash function, calculating the hash value, and deleting the same immediately after utilization, the leakage of the integrity verification key (hash key) may be prevented. The fingerprint of the original firmware including the hash value of each segment and the entire firmware image is generated (330), and the fingerprint is stored in the secure storage (340).

The forgery verification of the firmware is performed based on the integrity measurement (350) of the target firmware and the integrity verification (360) of comparison with the fingerprint. The integrity measurement unit 130 sequentially measures the integrity in a segment unit and transmits the measurement result value to the integrity verification unit 140.

The integrity verification unit 140 verifies the integrity by comparing the hash values of the segments of the target firmware with the corresponding hash values included in the fingerprint of the original firmware. When a malicious code is included in a specific segment, the integrity of the specific segment is broken, so that the forgery of the firmware may be detected. When the verification process is completed, the verification result is output.

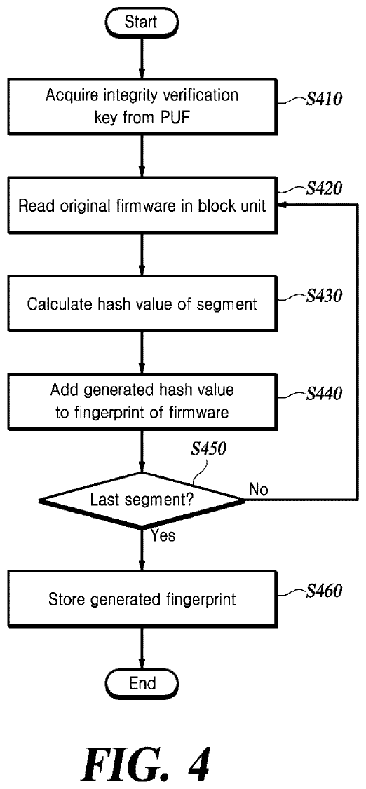

FIG. 4 is a flowchart illustrating a process in which the fingerprint generation unit 110 generates a fingerprint of an original firmware according to one embodiment of the present disclosure.

The fingerprint generation unit 110 acquires a hash key (integrity verification key) using the PUF (S410). The fingerprint generation unit 110 reads the original firmware in a block unit of a predetermined size to acquire a segment configuring a portion of the original firmware (S420). The fingerprint generation unit 110 calculates a hash value for the current segment using a hash function and a hash key (S430). The fingerprint generation unit 110 adds the generated hash value to the firmware fingerprint (S440).

The fingerprint generation unit 110 checks whether the current segment is the last segment of the original firmware (S450). If the current segment is not the last segment of the original firmware (S450-NO), the fingerprint generation unit 110 repeats stages S420 to S440 to acquire a hash value of the next segment. If the current segment is the last segment of the original firmware (S450-YES), the fingerprint generation unit 110 stores a fingerprint including a hash value for each segment in the secure storage 120 (S460).

In another embodiment of the present disclosure, the fingerprint generation unit 110 may add a hash value for the entire image of the original firmware to the fingerprint upon reaching the last segment of the original firmware. The fingerprint generation unit 110 may store a fingerprint including a hash value for each segment and a hash value for the entire image of the original firmware in the secure storage 120 (S460).

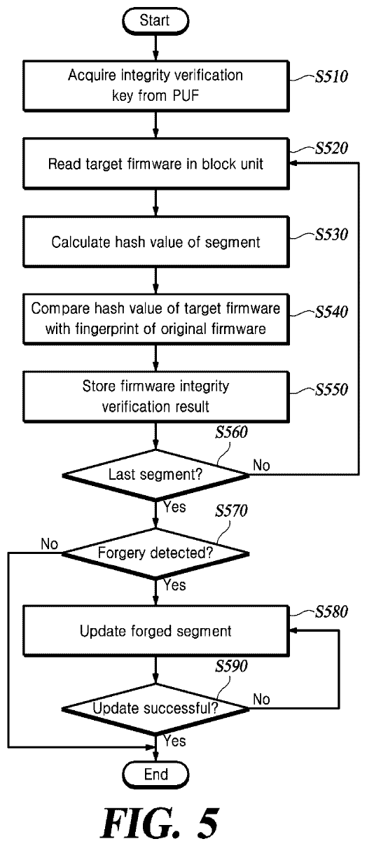

FIG. 5 is a flowchart illustrating a process in which the integrity measurement unit 130 and the integrity verification unit 140 verify the integrity of a target firmware according to one embodiment of the present disclosure.

The integrity measurement unit 130 acquires a hash key (integrity verification key) using the PUF (S510). The integrity measurement unit 130 reads the target firmware in a block unit of a predetermined size to acquire a segment configuring a portion of the target firmware (S520). The integrity measurement unit 130 calculates a hash value for the current segment using a hash function and a hash key, and transmits the generated hash value to the integrity verification unit 140 (S530).

The integrity verification unit 140 may receive a fingerprint of the original firmware from the secure storage 120. The integrity verification unit 140 may verify the current segment by comparing the hash value of the target firmware with the hash value included in the fingerprint of the original firmware (S540). The integrity verification unit 140 may store the integrity verification result for the corresponding segment (S550).

The integrity measurement unit 130 checks whether the current segment is the last segment of the target firmware S560. If the current segment is not the last segment of the target firmware (S560-NO), the integrity measurement unit 130 repeats stages S520 to S550 to verify the integrity of the next segment. If the current segment is the last segment of the target firmware (S560-YES), the integrity verification unit 140 checks whether there is a segment in which forgery has occurred among the segments of the target firmware (S570). If there is no segment in which forgery has occurred among the segments of the target firmware (S570-NO), the forgery verification process for the target firmware is terminated. If there is a segment in which forgery has occurred among the segments of the target firmware (S570-YES), the integrity verification unit 140 transmits the firmware integrity verification result to the Counterforgery unit 150. The firmware integrity verification result includes information on the segments in which forgery has occurred.

The Counterforgery unit 150 reads the firmware integrity verification result and performs an update of the segment in which forgery is detected (S580). The Counterforgery unit 150 may select and update only the segment in which forgery is detected, without updating the entire firmware image. The Counterforgery unit 150 may restore the forged segment by receiving an intact segment corresponding to the forged segment from the update server 200. By restoring only the segment in which forgery is detected, the Counterforgery unit 150 may quickly restore the forged firmware.

When the update of the forged segment is completed, the Counterforgery unit 150 checks the update result and checks whether the firmware restoration is successful (S590). If the firmware restoration is successful (S590-YES), the integrity verification process and restoration process for the target firmware are completed. If the firmware restoration fails (S590-NO), the Counterforgery unit 150 re-performs the update of the segment in which forgery has been detected (S580). When the number of update attempts exceeds a predetermined number, the Counterforgery unit 150 may store information about the update failure and terminate the integrity verification process and restoration process for the target firmware.

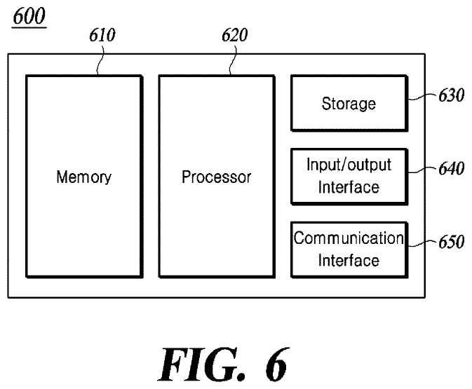

FIG. 6 is a block diagram schematically illustrating an exemplary computing device that may be used to implement a method or apparatus according to one embodiment of the present disclosure.

A computing device 600 may include all or part of a memory 610, a processor 620, a storage 630, an input/output interface 640, and a communication interface 650. The computing device 600 may structurally and/or functionally include at least a part of the apparatus of an embodiment of the present disclosure. The computing device 600 may include all or part of an embedded system of an IoT device.

The memory 610 may store a program that causes the processor 620 to perform a method or operation according to various embodiments of the present disclosure. For example, the program may include a plurality of commands executable by the processor 620, and the above-described method or operation may be performed by executing the plurality of commands by the processor 620. The memory 610 may be a single memory or a plurality of memories. In this connection, information required to perform the method or operation according to various embodiments of the present disclosure may be stored in a single memory or may be divided and stored in a plurality of memories. When the memory 610 is configured of a plurality of memories, the plurality of memories may be physically separated. The memory 610 may include at least one of a volatile memory and a non-volatile memory. The volatile memory may include a static random access memory (SRAM) or a dynamic random access memory (DRAM), and the non-volatile memory may include a flash memory, and the like.

The processor 620 may include at least one core capable of executing at least one command. The processor 620 may execute commands stored in the memory 610. The processor 620 may be a single processor or multiple processors.

The storage 630 maintains stored data even when power supplied to the computing device 600 is cut off. For example, the storage 630 may include non-volatile memory, and may include storage media such as magnetic tape, optical disk, or magnetic disk. The program stored in the storage 630 may be loaded into the memory 610 before being executed by the processor 620. The storage 630 may store a file written in a program language, and a program generated from the file by a compiler or the like may be loaded into the memory 610. The storage 630 may store data to be processed by the processor 620 and/or data processed by the processor 620.

The input/output interface 640 may provide an interface with an input device such as a keyboard, a mouse, etc., and/or an output device such as a display device, a printer, etc. A user may trigger execution of a program by the processor 620 through an input device and/or check the processing result of the processor 620 through an output device.

The communication interface 650 may provide access to an external network. The computing device 600 may communicate with other devices through the communication interface 650.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for verifying integrity of target firmware, the method comprising:
dividing original firmware into a plurality of original segments;
calculating a hash value for each of the plurality of original segments;
dividing the target firmware into a plurality of target segments;
calculating a hash value for each of the plurality of target segments; and
verifying the integrity of the target firmware by comparing the hash value of the target segment with the hash value of the original segment corresponding to the target segment for each of the plurality of target segments.

2. The method of claim 1, further comprising:
generating a fingerprint comprising the hash value for each of the plurality of original segments and storing the fingerprint in a secure storage,
wherein the verifying the integrity of the target firmware comprises acquiring the hash values for the plurality of original segments from the fingerprint.

3. The method of claim 1, wherein the verifying the integrity of the target firmware further comprises comparing a hash value for the entire image of the target firmware with a hash value for the entire image of the original firmware.

4. The method of claim 1, further comprising:
restoring the target firmware by updating segments whose integrity is damaged among the plurality of target segments.

5. The method of claim 1, wherein a hash key for calculating a hash value of a segment is generated using a PUF.

6. An apparatus for verifying integrity of target firmware, comprising:
a memory configured to store one or more instructions; and
a processor configured to execute the one or more instructions stored in the memory,
wherein the processor executes the one or more instructions to:
divide original firmware into a plurality of original segments;
calculate a hash value for each of the plurality of original segments;
divide the target firmware into a plurality of target segments;
calculate a hash value for each of the plurality of target segments; and
verify the integrity of the target firmware by comparing the hash value of the target segment with the hash value of the original segment corresponding to the target segment for each of the plurality of target segments.

7. The apparatus of claim 6, wherein the processor is further to:
generate a fingerprint comprising the hash value for each of the plurality of original segments;
store the fingerprint in a secure storage; and
acquire the hash values of the original segments from the fingerprint.

8. The apparatus of claim 6, wherein the processor is further to:
verify the integrity of the target firmware by comparing a hash value for the entire image of the target firmware with a hash value for the entire image of the original firmware.

9. The apparatus of claim 6, wherein the processor is further to:
restore the target firmware by updating only segments whose integrity is damaged among the plurality of target segments.

10. The apparatus of claim 6, wherein the processor is further to:
generate a hash key for calculating a hash value of a segment using a PUF.
